(19) United States
(12) Patent Application Publication
(10) Pub. No.: US 2005/0079972 A1
(43) Pub. Date: Apr. 14, 2005

(54) Bisorganic platinum compound/L zeolite catalysts for the aromatization of hydrocarbons

(76) Inventors: Tin-Tack Peter Cheung, Kingwood, TX (US); Darin B. Tiedtke, Kingwood, TX (US)

Correspondence Address: CHEVRON PHILLIPS CHEMICAL COMPANY LP, LAW DEPARTMENT - IP, P.O BOX 4910, THE WOODLANDS, TX, 77387-4910, US

(21) Appl. No.: 10/683,068

(22) Filed: Oct. 10, 2003

(51) Int. Cl. B01J 29/04

(52) U.S. Cl. 502/60

(57) ABSTRACT

We disclose an aromatization catalyst, prepared by a process comprising impregnating an L zeolite with platinum acetylacetonate. We also disclose a method of aromatizing a light naphtha, comprising reacting the light naphtha in the presence of an aromatization catalyst prepared by the process referred to above. The process of preparing the aromatization catalyst can also include loading the L zeolite with a Group IVB metal, a rare earth metal, or a lanthanide, such as titanium or thulium.

### BACKGROUND OF THE INVENTION

The present invention relates generally to the field of catalysts for the aromatization of hydrocarbons. More particularly, it concerns catalysts comprising L zeolite impregnated with bisorganic platinum compounds, such as platinum acetylacetonate.

Aromatization, the forming of benzene or other aromatic compounds from a non-aromatic hydrocarbon feedstock, such as a feedstock comprising a hexane or light naphtha, is known. Generally, a catalyst is required to catalyze the aromatization reaction. The catalysts are generally supported on a solid support. Processes for selecting and preparing the catalyst and the support are known but it is generally unpredictable what quality of catalyst (as measured by the conversion of the feedstock to products and the selectivity of the desired aromatic compound among the products) is prepared.

### SUMMARY OF THE INVENTION

In one embodiment, the present invention relates to an aromatization catalyst, prepared by a process comprising impregnating an L zeolite with a bisorganic platinum compound having the structure R>Pt<R, wherein R is an organic moiety comprising from 2 to about 20 carbon atoms. The process of preparing the aromatization catalyst can also include loading the L zeolite with a Group IVB metal, a rare earth metal, or a lanthanide, such as titanium or thulium.

In another embodiment, the present invention relates to an aromatization catalyst, comprising (i) an L zeolite, and (ii) a bisorganic platinum compound having the structure R>Pt<R, wherein R is an organic moiety comprising from 2 to about 20 carbon atoms.

In a further embodiment, the present invention relates to an aromatization catalyst, comprising (i) an L zeolite, (ii) a bisorganic platinum compound having the structure R>Pt<R, wherein R is an organic moiety comprising from 2 to about 20 carbon atoms, and (iii) a Group IVB metal, a rare earth metal, or a lanthanide.

In one embodiment, the present invention relates to a method of aromatizing a light naphtha, comprising reacting the light naphtha in the presence of an aromatization catalyst. In one embodiment, the aromatization catalyst is prepared by the process referred to above. In another embodiment, the aromatization catalyst consists essentially of (i) an L zeolite, and (ii) a bisorganic platinum compound having the structure R>Pt<R, wherein R is an organic moiety comprising from 2 to about 20 carbon atoms. In a further embodiment, the aromatization catalyst consists essentially of (i) an L zeolite, (ii) a bisorganic platinum compound having the structure R>Pt<R, wherein R is an organic moiety comprising from 2 to about 20 carbon atoms, and (iii) a Group IVB metal, a rare earth metal, or a lanthanide.

### DESCRIPTION OF ILLUSTRATIVE EMBODIMENTS

In one embodiment, the present invention relates to an aromatization catalyst, prepared by a process comprising:
impregnating an L zeolite with a bisorganic platinum compound having the structure R>Pt<R, wherein R is an organic moiety comprising from 2 to about 20 carbon atoms.

Zeolites are hydrous aluminum silicate minerals, and L zeolites are such minerals which possess a microstructure having a large number of channels. The channels are generally substantially parallel.

Zeolites also are anionic (possess negatively charged moieties), and as such a positively charged counterion is generally employed. In one embodiment, the counterion is potassium (i.e., K⁺).

In the process of preparing the aromatization catalyst, the L zeolite can be impregnated with a bisorganic platinum compound having the structure R>Pt<R, wherein R is an organic moiety comprising from 2 to about 20 carbon atoms. In one embodiment, the bisorganic platinum compound is platinum acetylacetonate (Pt(C₅O₂H₇)₂) (structure I):

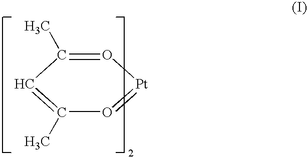

The impregnating can be performed by any appropriate technique apparent to the skilled artisan having the benefit of the present disclosure. In one embodiment, the impregnating step can comprise contacting the L zeolite with a solution comprising the bisorganic platinum compound in a solvent wherein the bisorganic platinum compound is at least partially soluble. In one embodiment, the solvent is an organic solvent. In one embodiment, the organic solvent is acetone. The solution can comprise from about 0.1 wt % to about 2.1 wt % the bisorganic platinum compound. In one embodiment, the solution can comprise from about 0.3 wt % to about 1.0 wt % the bisorganic platinum compound.

The duration, temperature, and other parameters of the contacting step can be selected such that maximum impregnation of the L zeolite by the bisorganic platinum compound is achieved, or less than maximum impregnation is achieved.

As used herein, the word “or” is used in the inclusive sense, i.e., any number of the various conditions linked by “or” may be met and remain within the teaching of the specification or the scope of the claims.

The result of the impregnating step is an L zeolite containing the bisorganic platinum compound. In one embodiment, the L zeolite can be impregnated with about 0.1 wt/wt % to about 10 wt/wt % platinum as the bisorganic platinum compound (i.e., about 0.1 to about 10 g Pt per 100 g L zeolite). In another embodiment, the L zeolite can be impregnated with about 0.3 wt/wt % to about 2 wt/wt % platinum as the bisorganic platinum compound (i.e., about 0.3 to about 2 g Pt per 100 g L zeolite). In another embodiment, the L zeolite can be impregnated with about 0.6 wt/wt % to about 1.4 wt/wt % platinum as the bisorganic platinum compound (i.e., about 0.6 to about 1.4 g Pt per 100 g L zeolite). In another embodiment, the L zeolite can be impregnated with about 1 wt/wt % platinum as the bisorganic platinum compound (i.e., about 1 g Pt per 100 g L zeolite).

In one embodiment, the process of preparing the aromatization catalyst can further comprise loading the L zeolite with a Group IVB metal, a rare earth metal, or a lanthanide. The Group IVB metal, the rare earth metal, or the lanthanide can be loaded onto the zeolite prior to impregnating or after impregnating. In one embodiment, the Group IVB metal, the rare earth metal, or the lanthanide is loaded onto the zeolite prior to impregnating.

Any Group IVB metal, rare earth metal, or lanthanide can be loaded into the L zeolite. In one embodiment, the Group IVB metal, the rare earth metal, or the lanthanide is titanium or thulium.

The loading can be performed by any appropriate technique apparent to the skilled artisan having the benefit of the present disclosure. In one embodiment, an aqueous solution of the Group IVB metal, the rare earth metal, or the lanthanide (“the metal”) can be prepared with the metal present as a salt. The solution can be added dropwise to the catalyst. After addition, the loaded catalyst can be dried, e.g., in a drying oven at about 100° C. to about 150° C. for about 1 hr to about 4 hr, among other techniques. The dried loaded catalyst can then be calcined, e.g., heated in air at about 100° C. to about 400° C. for about 4 hr to about 36 hr, among other techniques.

In one embodiment, the Group IVB metal, the rare earth metal, or the lanthanide is present after loading at from about 0.5 wt % to about 10 wt % (i.e., from about 0.5 g metal per 100 g zeolite to about 10 g metal per 100 g zeolite), about 1 wt % to about 5 wt % (i.e., from about 1 g metal per 100 g zeolite to about 5 g metal per 100 g zeolite), or about 2 wt % to about 3 wt % (i.e., from about 2 g metal per 100 g zeolite to about 3 g metal per 100 g zeolite).

Further techniques can be used to prepare the aromatization catalyst for use, including the use of heat, anoxic gas flow, hydrogen flow, dehydration, or two or more of the foregoing, among others apparent to the skilled artisan having the benefit of the present disclosure.

Alternatively, in one embodiment, the present invention relates to an aromatization catalyst, comprising (i) an L zeolite, and (ii) a bisorganic platinum compound having the structure R>Pt<R, wherein R is an organic moiety comprising from 2 to about 20 carbon atoms.

Also alternatively, in one embodiment, the present invention relates to an aromatization catalyst, comprising (i) an L zeolite, (ii) a bisorganic platinum compound having the structure R>Pt<R, wherein R is an organic moiety comprising from 2 to about 20 carbon atoms, and (iii) a Group IVB metal, a rare earth metal, or a lanthanide.

In another embodiment, the present invention relates to a method of aromatizing a hydrocarbon, comprising reacting the hydrocarbon in the presence of an aromatization catalyst prepared by a process comprising impregnating an L zeolite with a bisorganic platinum compound as described above.

A “hydrocarbon” is a composition of one or more compounds comprising carbon and one or more hydrogen atoms. In one embodiment, the hydrocarbon is a “light naphtha,” comprising about five to about nine carbon atoms and one or more hydrogen atoms. In one embodiment, the hydrocarbon is a hexane, which is any compound comprising one or more hydrogen atoms and six carbon atoms, wherein all the bonds between carbon atoms are single bonds.

In one embodiment, the hydrocarbon can further comprise other compounds or contaminants, such as organic compounds comprising oxygen atoms, nitrogen atoms, or other elements other than hydrogen or carbon; elemental sulfur; and compounds comprising sulfur atoms; among others. In one embodiment, the hydrocarbon comprises less than 50 ppb sulfur (by weight of all sulfur atoms).

The catalyst can be prepared by the process described above. Alternatively, in one embodiment, the present invention relates to an aromatization catalyst, comprising (i) an L zeolite, and (ii) a bisorganic platinum compound having the structure R>Pt<R, wherein R is an organic moiety comprising from 2 to about 20 carbon atoms. Also alternatively, in one embodiment, the present invention relates to an aromatization catalyst, comprising (i) an L zeolite, (ii) a bisorganic platinum compound having the structure R>Pt<R, wherein R is an organic moiety comprising from 2 to about 20 carbon atoms, and (iii) a Group IVB metal, a rare earth metal, or a lanthanide.

The reacting step can be performed at any appropriate temperature, pressure, duration, or other parameter apparent to the skilled artisan having the benefit of the present disclosure as being useful in the aromatization of a hydrocarbon, such as light naphtha. The reacting step can be performed as a batch process or a continuous process. In one embodiment, the reacting step is performed at about 500° C. for about 22 hr.

The result of the method is an aromatic compound, typically benzene. In one embodiment, the percent conversion (the weight percentage of hydrocarbon added to the reactor that is converted to other compounds, herein, “converted compounds”) is at least about 80%, such as about 84%, 93%, or 98%. In one embodiment, the benzene percent selectivity (the weight percentage of converted compounds made up by benzene) is at least about 75%, such as 84% or 87%. In other words, the use of an aromatization catalyst prepared according to the present specification can lead to the conversion of 100 g hydrocarbon to at least about 85 g benzene, about 13 g other converted compounds, and about 2 g hydrocarbon.

A further understanding of the present invention and its advantages will be provided by the following examples. The following examples are presented to exemplify embodiments of the invention. Specific details described in each example should not be construed as necessary features of the invention. Those of skill in the art should, in light of the present disclosure, appreciate that many changes can be made in the specific embodiments which are disclosed and still obtain a like or similar result without departing from the spirit and scope of the invention. All numerical values are approximate. When numerical ranges are given, it should be understood that embodiments outside the stated ranges may still fall within the scope of the invention.

### EXAMPLE 1

### Preparation of a Platinum Acetylacetonate/Thulium/KL Zeolite Catalyst

First, 286 mg Tm(NO₃)₃·5H₂O was dissolved in 6.1 mL distilled water. The thulium solution was added dropwise to 10.6 g KL zeolite with continuous stirring. The Tm/KL zeolite was poured into a quartz calcining tube and treated to the following: (i) air, 120° C., 90 min; (ii) air, 200° C., 1 hr; (iii) air, 320° C., 2.5 hr; (iv) N₂, 350° C., 20 min; (v) N₂, cooling from 350° C. to room temperature, 90 min.

Then, 10.5 g Tm/KL zeolite was transferred to a 250 mL flask. The flask was evacuated and 214 mg Pt acetylacetonate (1 wt % Pt relative to the KL zeolite) was dissolved in about 50 mL acetone. The platinum compound/acetone solution was poured into the Tm/KL zeolite and the resulting suspension was stirred under static air. About 64-72 hr later, the acetone was removed from the flask by vacuum. About 16 hr later, the catalyst was calcined (air, 340° C., 3 hr) and allowed to cool.

### EXAMPLE 2

### Aromatization of Hexanes Using Platinum Acetylacetonate/KL Zeolite

A reactor was loaded with 0.42 g of platinum acetylacetonate/KL zeolite (1% Pt). A flow of 100 cc/min N₂ through the reactor was begun. The reactor was heated to 200° C. with a rate of temperature change of +5° C./min, and then the temperature was held at 200° C. for 1 hr. The 100 cc/min N₂ was stopped and a flow of 112 cc/min H₂ was begun. The temperature was held at 200° C. for 1 hr, and then increased to 540° C. with a rate of temperature change of +5° C./min. The temperature was held at 540° C. for 1 hr; the flow of a mixture of hexanes (GC Resolve grade, Fisher Scientific, Pittsburgh, Pa.) at 0.05 cc/min was begun. The temperature of the reactor catalyst bed was held at approximately 500° C. and the hydrogen and hexanes flows were continued for about 80 hr; the H₂ flow was adjusted to 168 cc/min at the 17 hr point and to 224 cc/min at the 22.25 hr point.

The following table (Table 1) reports the conversion and selectivity to benzene, toluene, and other light aromatic compounds (as fractions) at various time points as measured by gas chromatography.

TABLE 1

| Time, hr | Conversion | Selectivity |
|---|---|---|
| 16 | 0.862 | 0.889 |
| 17.65 | 0.840 | 0.895 |
| 22.23 | 0.843 | 0.874 |
| 23.98 | 0.829 | 0.892 |
| 75.35 | 0.797 | 0.884 |

Converted compounds other than benzene included alkanes comprising from 1 to 7 carbon atoms and hexenes. Roughly 99.5 wt % of the light aromatics generated by the reaction was made up of benzene.

### EXAMPLE 3

### Aromatization of Hexanes Using Platinum Acetylacetonate/Titanium/KL Zeolite

A reactor was loaded with 0.42 g of platinum acetylacetonate/titanium/KL zeolite (1% Pt, 0.53% Ti). A flow of 100 cc/min N₂ through the reactor was begun. The reactor was heated to 200° C. with a rate of temperature change of +5° C./min, and then the temperature was held at 200° C. for 90 min. The 100 cc/min N₂ was stopped and a flow of 224 cc/min H₂ was begun. The temperature was held at 200° C. for 1 hr, and then increased to 540° C. with a rate of temperature change of +5° C./min. The temperature was held at 540° C. for 1 hr; the flow of a mixture of hexanes (GC Resolve grade, Fisher Scientific, Pittsburgh, Pa.) at 0.05 cc/min was begun. The temperature of the reactor catalyst bed was held at approximately 540° C. and the hydrogen and hexanes flows were continued for about 22 hr; the hexanes flow was then stopped for refilling and the reactor was kept at 540° C. under the H₂ flow during the refilling process. Thereafter, the hydrogen and hexanes flows were continued for about an additional 113 hr.

The following table (Table 2) reports the conversion and selectivity to benzene, toluene, and other light aromatic compounds (as fractions) at various time points as measured by gas chromatography.

TABLE 2

| Time, hr | Conversion | Selectivity |
|---|---|---|
| 1 | 0.947 | 0.921 |
| 16.6 | 0.916 | 0.913 |
| 22.13 | 0.927 | 0.915 |
| 24.5 | 0.943 | 0.913 |
| 40.32 | 0.927 | 0.911 |
| 45.27 | 0.929 | 0.909 |
| 49.15 | 0.926 | 0.905 |
| 65.73 | 0.923 | 0.904 |
| 71.57 | 0.932 | 0.911 |
| 136.07 | 0.912 | 0.901 |

Converted compounds other than benzene included alkanes comprising from 1 to 7 carbon atoms and hexenes. Roughly 99.25-99.5 wt % of the light aromatics generated by the reaction was made up of benzene.

### EXAMPLE 4

### Aromatization of Hexanes Using Platinum Acetylacetonate/Thulium/KL Zeolite

A reactor was loaded with 0.43 g of platinum acetylacetonate/thulium/KL zeolite (1% Pt, 1% Tm). A flow of 100 cc/min N₂ through the reactor was begun. The reactor was heated to 200° C. with a rate of temperature change of +5° C./min, and then the temperature was held at 200° C. for 1 hr. The 100 cc/min N₂ was stopped and a flow of 150 cc/min H₂ was begun. The temperature was held at 200° C. for 1 hr, and then increased to 540° C. with a rate of temperature change of +5° C./min. The temperature was held at 540° C. for 1 hr; the flow of a mixture of hexanes (GC Resolve grade, Fisher Scientific, Pittsburgh, Pa.) at 0.05 cc/min was begun. The temperature of the reactor catalyst bed was held at approximately 500° C. and the hydrogen and hexanes flows were continued for about 96 hr; the reactor was shut down after 21 hr and restarted according to the procedure described above.

The following table (Table 3) reports the conversion and selectivity to benzene, toluene, and other light aromatic compounds (as fractions) at various time points as measured by gas chromatography.

TABLE 3

| Time, hr | Conversion | Selectivity |
|---|---|---|
| 0.94 | 0.855 | 0.903 |
| 15.73 | 0.975 | 0.902 |
| 23.79 | 0.956 | 0.895 |
| 41.23 | 0.987 | 0.900 |
| 46.03 | 0.981 | 0.898 |
| 48.79 | 0.984 | 0.898 |
| 64.34 | 0.978 | 0.892 |
| 72.31 | 0.982 | 0.896 |
| 89.18 | 0.979 | 0.885 |
| 95.54 | 0.967 | 0.882 |

Converted compounds other than benzene included alkanes comprising from 1 to 7 carbon atoms and hexenes. Roughly 99.5-99.75 wt % of the light aromatics generated by the reaction was made up of benzene.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the methods described herein without departing from the concept, spirit and scope of the invention as defined by the appended claims.

1. An aromatization catalyst, prepared by a process comprising:
impregnating an L zeolite with a bisorganic platinum compound having the structure R>Pt<R, wherein R is an organic moiety comprising from 2 to about 20 carbon atoms.

2. The aromatization catalyst of claim 1, wherein the bisorganic platinum compound is platinum acetylacetonate.

3. The aromatization catalyst of claim 1, comprising about 0.1 wt/wt % to about 10 wt/wt % platinum as the bisorganic platinum compound.

4. The aromatization catalyst of claim 1, wherein the L zeolite comprises a potassium counterion.

5. The aromatization catalyst of claim 1, wherein the impregnating step comprises contacting the L zeolite with a solution of the bisorganic platinum compound in an organic solvent.

6. The aromatization catalyst of claim 5, wherein the organic solvent is acetone.

7. The aromatization catalyst of claim 1, wherein the process of preparing further comprises loading the L zeolite with a Group IVB metal, a rare earth metal, or a lanthanide.

8. The aromatization catalyst of claim 7, wherein the Group IVB metal, the rare earth metal, or the lanthanide is titanium or thulium.

9. An aromatization catalyst, comprising:
an L zeolite, and
a bisorganic platinum compound having the structure R>Pt<R, wherein R is an organic moiety comprising from 2 to about 20 carbon atoms.

10. The aromatization catalyst of claim 9, wherein the bisorganic platinum compound is platinum acetylacetonate.

11. The aromatization catalyst of claim 9, wherein the platinum is present at about 0.1 wt/wt % to about 10 wt/wt % platinum as the bisorganic platinum compound.

12. The aromatization catalyst of claim 9, wherein the L zeolite comprises a potassium counterion.

13. An aromatization catalyst, comprising:
an L zeolite,
a bisorganic platinum compound having the structure R>Pt<R, wherein R is an organic moiety comprising from 2 to about 20 carbon atoms, and
a Group IVB metal, a rare earth metal, or a lanthanide.

14. The aromatization catalyst of claim 13, wherein the Group IVB metal, the rare earth metal, or the lanthanide is titanium or thulium.

15. A method of aromatizing a hydrocarbon, comprising:
reacting the hydrocarbon in the presence of an aromatization catalyst prepared by a process comprising impregnating an L zeolite with a bisorganic platinum compound having the structure R>Pt<R, wherein R is an organic moiety comprising from 2 to about 20 carbon atoms.

16. The method of claim 15, wherein the bisorganic platinum compound is platinum acetylacetonate.

17. The method of claim 15, wherein the impregnating step comprises contacting the L zeolite with a solution of the bisorganic platinum compound in an organic solvent.

18. The method of claim 17, wherein the organic solvent is acetone.

19. The method of claim 15, wherein the L zeolite comprises a potassium counterion.

20. The method of claim 15, wherein the hydrocarbon is a light naphtha.

21. The method of claim 15, wherein the hydrocarbon is a hexane.

22. The method of claim 15, wherein the reacting step is performed at about 500° C. for at least about 24 hr.

23. The method of claim 15, wherein the preparation of the aromatization catalyst further comprises loading the L zeolite with a Group IVB metal, a rare earth metal, or a lanthanide.

24. The method of claim 23, wherein the Group IVB metal, the rare earth metal, or the lanthanide is titanium or thulium.

25. A method of aromatizing a hydrocarbon, comprising:
reacting the hydrocarbon in the presence of an aromatization catalyst comprising (i) an L zeolite, and (ii) a bisorganic platinum compound having the structure R>Pt<R, wherein R is an organic moiety comprising from 2 to about 20 carbon atoms.

26. A method of aromatizing a hydrocarbon, comprising:
reacting the hydrocarbon in the presence of an aromatization catalyst comprising (i) an L zeolite, (ii) a bisorganic platinum compound having the structure R>Pt<R, wherein R is an organic moiety comprising from 2 to about 20 carbon atoms, and (iii) a Group IVB metal, a rare earth metal, or a lanthanide.
